(19) United States
(12) Patent Application Publication
(10) Pub. No.: US 2012/0082834 A1
(43) Pub. Date: Apr. 5, 2012

(54) RADIATION-ABSORBING MATERIAL

(75) Inventors: Hendrik Wermter, Eltville (DE); Rüdiger Wissemborski, Gau-Algesheim (DE); Thomas Janssen, Mainz (DE)

(73) Assignee: Chemische Fabrik Budenheim KG, Budenheim (DE)

(21) Appl. No.: 13/254,118

(22) PCT Filed: Mar. 2, 2010
(86) PCT No.: PCT/EP2010/052628

§ 371 Date: Oct. 26, 2011

(30) Foreign Application Priority Data
Mar. 4, 2009 (DE) 10 2009 001 335.0

(51) Int. Cl. B32B 27/18; C08K 3/32

(52) U.S. Cl. 428/220; 428/339; 524/417

(57) ABSTRACT

Radiation-absorbing, plastics-based material consisting of a polymer matrix with an absorber material or mixture of absorber materials contained therein, wherein the absorber material or mixture of absorber materials is selected from phosphates, condensed phosphates, phosphonates, phosphites and mixed hydroxide-phosphate-oxoanions of copper (Cu), tin (Sn), calcium (Ca) and/or iron (Fe) and is present finely distributed, dispersed or dissolved in the polymer matrix.

### SUBJECT OF THE INVENTION

The invention relates to a radiation-absorbing plastics-based material consisting of at least one polymer matrix with an absorber material or mixture of absorber materials contained therein.

### BACKGROUND OF THE INVENTION

Packaging for commercial products of all types, e.g. also foodstuffs, often consists completely or partly of polymer material (plastic). Often, several pieces of individual products or a number of different products or product parts are tied or held together by the packaging. Liquid foodstuffs such as drinks, oil, soups, tinned fruit and vegetables containing liquid, but also non-food liquids such as e.g. household cleaning and care products, medicinal products, machine oils and many others, are stored and put on the market in plastic containers such as e.g. in bottles, canisters and cans. In addition to the preservation of the products, a further essential reason for using packaging is to protect products against dirt, damage etc. Often the packaging is partly or completely transparent, in order that the product contained therein can be seen.

Product packaging is often exposed to artificial light or daylight and often also to strong solar radiation. The products and also the packaging can often be damaged as a result. Light and solar radiation result in the heating of the packaged products, which often significantly impairs the shelf life, in particular where foodstuffs are concerned. Heating can result in increased growth of bacteria, moulds and yeasts, and radiation can also cause a change in the foodstuffs as a result of oxidation processes. In addition to the edibility of the foodstuffs, increased contamination by light and heat also often has a disadvantageous effect on the outward appearance and consistency of the products.

Furthermore, light and solar radiation also often has a disadvantageous effect on the packaging itself and the products contained therein in the case of non-food products. Thus radiation can result in the discoloration of the plastic or make the latter brittle, friable or hard over time. Polymer materials can be degraded by photoinduced oxidation if for example they are exposed for an extended period to direct sunlight. This degradation can lead e.g. to crosslinking, embrittlement, bleaching and sometimes concomitant loss of mechanical properties. Plastics materials age more rapidly under the action of radiation.

The radiation which is particularly damaging to packaging and/or packaged products is predominantly radiation in the ultraviolet region and in the infrared region of the spectrum, i.e. high-energy UV radiation and/or IR thermal radiation.

Plastic windows, roofs, noise protection barriers etc. often also comprise transparent components consisting of materials which are to a certain extent sensitive to UV radiation, such as e.g. polycarbonate or PMMA, and thus must be protected by UV stabilizers. In particular, roofs and windows are often required to insulate rooms against heat transfer, i.e. to not allow thermal radiation through. For this, IR absorbers and reflectors are currently already incorporated into the polymer matrix. Furthermore, roofs in particular must also be protected against attack by green algal growth or mould.

It would therefore be advantageous for a polymer material, which is used e.g. for producing packaging, to be finished or modified such that it largely blocks UV radiation and/or IR radiation, with the result that damage by the radiation to the material itself and/or to a product behind the material is reduced.

At the same time, the finishing or modification of the polymer material should block light from the visible region of the spectrum to only a small degree or if possible not at all, in order to make it possible to produce transparent (translucent) polymer material as is widely used for packaging, in order that the product can be seen from the outside (high transparency).

Furthermore, the finishing or modification of the polymer material should result in as small as possible a contribution of its own undesired colour or clouding of the polymer material. The processability and material properties of the polymer material should be adversely affected to only a small degree or if possible not at all. In addition, the finished or modified polymer material, in particular if it is used in the food industry, should not emit any substances that are dangerous to health or affect flavour. This also applies in particular for example to items with which humans and animals, in particular babies and infants, come into contact, such as e.g. toys.

WO-A-03/033582 describes an agent for absorbing UV radiation based on mixed cerium and titanium phosphate for incorporation into a polymer material.

EP-A-1 666 927 describes an infrared radiation absorbing sun protection film made of polyester film with a visually clear metallizing or metal sputtering. The metal coating reflects the irradiating solar energy and allows high-contrast, damped light to penetrate.

US-A-20050277709 describes multilayer composite glass materials which absorb in the region of infrared (IR) and near infrared (NIR) light. The composite glass contains dielectric cores from the group titanium dioxide, silicon dioxide, colloidal silicon dioxide, gold sulphide, polymethyl methacrylate and polystyrene.

U.S. Pat. No. 7,258,923 describes multilayer items with an innermost layer of a thermoplastic polymer which contains IR-absorbing additives which are selected from the borides of transition metals and lanthanides.

U.S. Pat. No. 5,830,568 describes a composite glass with an intermediate layer of PVB or ethylvinylacetate copolymer with functional ultrafine metal oxide particles dispersed therein for a light absorption.

U.S. Pat. No. 6,620,872 describes a PVB film which contains an effective quantity of lanthanide borides and at least tin oxide or antimony tin oxide for the absorption of IR radiation.

EP-A-0 371 949 describes a sun protection composite glass with at least one reflective layer made of metal which reflects no more than 2% in the visible region. The adjacent layer contains a dielectric material selected from oxides of Cr, Ta, W, Zn, Al, In and Ti as well as ZnS.

EP-A-1 640 348 describes the production of a laminar structure with a strong filter action against solar radiation.

Unlike organic absorber systems, when large quantities of inorganic absorber materials for UV radiation are used in order to achieve an adequate absorption effect in the relevant wavelength region, the problem often arises that the high quantities mean that they no longer have sufficient transparency, with the result that the matrix containing the absorber material is usually strongly coloured or clouded.

Organic absorber materials often have the disadvantage that they are thermally unstable and are decomposed when worked into a polymer material or its further processing, which often takes place in the molten state or in the heat-softened state customarily at over 200° C.

### OBJECT

The object of the invention was to provide a radiation-absorbing, plastics-based material which

is suitable among other things as packaging material for commercial products, in particular foodstuffs, or cosmetics,

blocks or absorbs UV radiation and/or IR radiation to a large extent,

simultaneously blocks or absorbs light from the visible region of the spectrum to only a small degree or if possible not at all,

makes as small as possible a contribution of its own undesired colour or clouding of the polymer material because of the absorber material,

has good processability and good material properties and

does not emit substances that are dangerous to health because of the absorber material.

### DESCRIPTION OF THE INVENTION

This object is achieved by a radiation-absorbing, plastics-based material consisting of a polymer matrix with an absorber material or mixture of absorber materials contained therein, wherein the absorber material or mixture of absorber materials is selected from phosphates, condensed phosphates, phosphonates, phosphites and mixed hydroxide-phosphate-oxoanions of copper (Cu), tin (Sn), calcium (Ca) and/or iron (Fe) and is present finely distributed, dispersed or dissolved in the polymer matrix.

The plastics-based materials according to the invention absorb UV radiation and/or IR radiation very well. At the same time, the absorber materials incorporated into the polymer material do not substantially impair the transparency of the polymer materials in the visible region of the spectrum.

The polymer materials with the absorber materials according to the invention are therefore particularly suitable for example for producing packaging materials, e.g. packaging films, blister packs, plastic cans, drinks bottles such as PET bottles, etc.

However, the materials according to the invention can also be used for other purposes where UV radiation and/or IR radiation due to light and solar radiation must be blocked, and if necessary a high transparency (translucence) must simultaneously be guaranteed. Examples of applications are car glazing, greenhouses, optical elements made of plastic or glass, such as e.g. spectacle lenses where the eyes of the spectacles wearer are to be protected against the harmful effects of UV radiation. Further examples of applications are clothing and head coverings for protection against strong UV radiation caused by sunshine. Here, layers of the material according to the invention can advantageously be applied to textiles or arranged to form a composite with the latter. The textiles can also be produced from polymer fibres of the material according to the invention.

Further applications of the material according to the invention are plastics products that must withstand strong UV and/or IR radiation, for example items that are permanently exposed to daily solar radiation outdoors. With such items, the permanent UV and/or IR solar radiation leads to an embrittlement of the material, oxidation, bleaching and ultimately to a rapid wearing or rapid aging. With the materials according to the invention, UV and/or IR rays are already largely absorbed close to the surface and cannot therefore penetrate deep into the material and release their destructive effect there. Medical products or plastic pipes can also advantageously be produced from the material according to the invention.

In one embodiment of the invention, the absorber material is selected from tritin phosphate (CAS 15578-32-3), tricopper diphosphate (CAS 7798-23-4), copper diphosphate (CAS 10102-90-6), copper hydroxide phosphate (CAS 12158-74-6) and mixtures thereof.

According to the invention, the absorber material is particularly preferably a copper compound such as tricopper phosphate, copper diphosphate or copper hydroxide phosphate, or a mixture comprising at least one copper compound. The absorber material is quite particularly preferably copper hydroxide phosphate or a mixture comprising at least copper hydroxide phosphate.

The above-named copper phosphate compounds have proved to be particularly good absorption materials for UV and/or IR radiation. Copper hydroxide phosphate is quite particularly efficient. It absorbs IR radiation excellently. In this respect copper hydroxide phosphate has proved to be the best of the metal phosphate compounds investigated by the inventors as absorber materials. Overall, it is surpassed among the inorganic absorber materials only by ITO (indium tin oxide) which is not however taken into consideration according to the invention as, due to the indium, it is expensive and poses a risk to health.

The inclusion of the copper phosphate compounds according to the invention in polymer materials as packaging material or other commercial products has further substantial advantages in addition to the absorbing effect for UV and/or IR radiation. Packaging materials, in particular polymer films for packaging foodstuffs, are usually sterilized with hydrogen peroxide before use. As a rule, the hydrogen peroxide then decomposes by itself, but this takes a certain amount of time, with the result that it is often not completely degraded when the material is used for packaging foodstuffs for example. Residual hydrogen peroxide can then exert its oxidizing effect, with all its disadvantages, on the packaged foodstuffs. This is often precisely the opposite of what is intended with a plastic packaging, namely among other things to protect the foodstuff against contact with air and thus against the oxidative effect of atmospheric oxygen.

It has surprisingly been shown that the compounds used according to the invention as absorption material, in particular the copper compounds, quite particularly copper hydroxide phosphate, have an accelerating or catalytic effect on the degradation or decomposition of peroxides, such as hydrogen peroxide. If packaging materials of the type according to the invention containing copper compounds according to the invention are used to package foodstuffs, and sterilized in advance with hydrogen peroxide, the material according to the invention promotes the rapid and generally complete decomposition of the hydrogen peroxide before the packaging material is used or comes into contact with the products to be packaged.

The inclusion of copper phosphate compounds according to the invention in plastics-based materials as packaging material or other commercial products also has a further advantageous effect in addition to the above-described absorbing effect for UV and/or IR radiation and the further surprising effect on the decomposition of hydrogen peroxide. The materials according to the invention with incorporated copper phosphate compounds according to the invention mostly also have a bacteriostatic and/or sterilizing effect. This has substantial advantages compared with conventional plastics-based materials, in particular when used as packaging materials for foodstuffs. The likelihood of premature spoilage of foodstuffs can thus be reduced, for example. The materials according to the invention are also suitable from the point of view of bacteriostatic and/or sterilizing effect for producing medical products or plastic tubes where contamination is particularly undesirable.

The discovered bacteriostatic and/or sterilizing effect of the plastics-based materials according to the invention with incorporated copper phosphate compounds according to the invention was also surprising because the copper phosphate compounds in the polymer matrix are very largely, i.e. up to the outermost surface of the material, enclosed by the polymer material and thus kept away from the products or germs thereon. Seemingly only a very small active proportion of the copper compounds is therefore located right next to the surface. The now discovered effect was therefore not to be expected.

A substantial advantage of the now discovered bacteriostatic and/or sterilizing effect of the polymer materials according to the invention with incorporated copper phosphate compounds according to the invention is also that the copper phosphate compounds can now, due to their bacteriostatic and/or sterilizing effect, largely replace silver compounds used for the same purpose. Although silver compounds are highly effective in this regard, they have the disadvantage that they are becoming increasingly more expensive and are persistent when ingested into the body, i.e. remain in the body and are degraded or excreted only slowly or not at all. In contrast, ingested copper is not persistent, being excreted from the body via the liver/gall.

The bacteriostatic and/or sterilizing effect of metallic copper is known. However, it was surprisingly shown that, in order to achieve a corresponding bacteriostatic effect upon incorporation into a polymer matrix, a much smaller quantity or dose of the copper phosphate compounds according to the invention is required than when metallic copper is used. In connection with the applications of the present invention described herein, the copper phosphate compounds according to the invention, in particular copper hydroxide phosphate, have the further advantage that they are clear or colourless when incorporated into the polymer matrix, whereas metallic copper is red and the polymer material would become discoloured accordingly.

In a further embodiment of the invention, the absorber material is present in the polymer matrix in a quantity of from 0.0005 to 10 wt.-%. Alternatively, the absorber material is present in the polymer matrix in a quantity of from 0.05 to 5 wt.-% or from 0.5 to 3 wt.-% or from 1 to 2 wt.-%. The absorber material is expediently finely distributed, dispersed or dissolved in the polymer matrix. The more finely and more finely-particled the material is distributed in the polymer matrix, the less is the danger of clouding or discolouring of the polymer material due to the absorber material, in particular if greater quantities of the absorber material are used, in order to achieve a particularly high effect. T he quantity of absorber material in the polymer matrix influences the absorbency of the material, among other things. Depending on the quantity used, an almost complete absorption of the light in the UV region and/or IR region can be achieved.

In a further embodiment of the invention, the polymer matrix is a biopolymer, preferably comprising starch, cellulose, other polysaccharides, polylactic acid or polyhydroxy fatty acid, or a thermoplastic polymer, preferably selected from the group consisting of polyvinyl butyral (PVB), polypropylene (PP), polyethylene (PE), polyamide (PA), polybutylene terephthalate (PBT), polyethylene terephthalate (PET), polyester, polyphenylene oxide, polyacetal, polymethacrylate, polyoxymethylene, polyvinyl acetal, polystyrene, acryl-butadiene-styrene (ABS), acrylonitrile-styrene-acrylester (ASA), polycarbonate, polyethersulphone, polyetherketone, polyvinyl chloride, thermoplastic polyurethane and/or their copolymers and/or mixtures thereof.

In a further embodiment of the invention, the absorber material has an average particle size (d50) of less than 20 μm. Preferably, the average particle size (d50) is less than 10 pm, particularly preferably less than 200 nm, quite particularly preferably less than 60 nm or 50 nm or 40 nm. The smaller the particle size, the less the danger of clouding or discolouring of the polymer material due to the absorber material. At the same time, the finer the particles of the absorber material are, the larger its specific surface area, as a result of which the available active surface area, and thus as a rule also the effect, increases.

In a further embodiment of the invention, the polymer material is present as a film, layer or thin sheet with a thickness in the range of from 1 μm to 20 mm or in the range of from 50 μm to 10 mm or in the range of from 100 μm to 5 mm or in the range of from 200 μm to 1 mm. The thickness of the layer or sheet depends primarily on the desired mechanical and optical properties as well as the required barrier properties and the required stability of the plastics-based material.

In a further embodiment of the invention, a mixture of at least two absorber materials is present in the polymer matrix. As a result, for example the effects of individual absorber materials according to the invention can be combined or brought together additively or synergistically. For example, different absorber materials can absorb to different extents in different regions of the spectrum, with the result that the absorption over specific regions of the spectrum is achieved better through a coordinated combination of absorber materials.

In a further embodiment of the invention, the radiation-absorbing polymer material according to the invention has a transmittance I_{T}/I₀ of ≦0.60, preferably ≦0.50, particularly preferably ≦0.30 for ultraviolet radiation (UV) over the wavelength range of from 200 to 380 nm, preferably from 200 to 400 nm, wherein I₀=intensity of the incident radiation and I_{T}=intensity of the penetrating radiation.

In a further embodiment of the invention, the radiation-absorbing polymer material according to the invention has a transmittance I_{T}/I₀ of ≦0.50, preferably ≦=0.30, particularly preferably ≦0.25 for infrared radiation (IR/NIR) over the wavelength range of from 900 to 1500 nm, wherein I₀=intensity of the incident radiation and I_{T}=intensity of the penetrating radiation.

In a further embodiment of the invention, the radiation-absorbing polymer material according to the invention has a transmittance I_{T}/I₀ of >0.60, preferably >0.70, particularly preferably >0.80 for visible light (VIS) over the wavelength range of from 400 to 900 nm, wherein I₀=intensity of the incident radiation and I_{T}=intensity of the penetrating radiation.

In a further embodiment of the invention, the radiation-absorbing, plastics-based material according to the invention is formed as a film, layer or thin sheet with a thickness in the range of from 1 μm to 3 mm, and is present with at least one further layer in a multi-ply structure, wherein the at least one further layer is selected from a film-type or layer-type polymer matrix with or without absorber material, an aluminium layer and/or a paper or cardboard layer.

The invention also comprises the use of the radiation-absorbing polymer material according to the invention for producing packaging materials for commercial products, preferably packaging materials for foodstuffs, cosmetics or medical products, or for producing medical products, plastic tubes, roofs, windows or noise protection elements.

The absorber materials according to the invention have the advantage, compared with organic UV and IR absorbers, that they are thermally much more stable and are therefore not destroyed at the production and processing temperatures of the polymer materials into which they are incorporated.

The radiation-absorbing, plastics-based materials according to the invention have a further advantage that, due to their absorbability for IR radiation, they can be heated in a targeted manner with corresponding IR sources or IR emitters, whereby particular possibilities for improving shapability and processability result. Among other things, the polymer material ca n be heated and shaped very rapidly and energy-efficiently. This can be advantageous during both production and further processing.

The measurement of the radiation absorption, i.e. the UV absorption, IR absorption and the absorption or transmission in the visible wavelength region, is advantageously carried out with a Varian UV-Vis-VIR spectrophotometer, Cary 5000model at specific wavelengths or over the whole relevant wavelength region.

The transparency or transmittance of the polymer matrix is determined or influenced on the one hand by the selected absorber material, but on the other also by the quantity or concentration used and the particle size of the absorber material used. No generally valid ideal concentration can be given, as the transparency can also be influenced very differently by the respective polymer material used. However, the setting of the optimum concentration of a selected absorber material is within the competence of the average person skilled in the art in the field and is to be carried out depending on the desired transparency by means of a reasonable number of tests.

The chosen concentration of the absorber material is to be such that, in the resulting polymer matrix, as high as possible an absorption takes place in the IR region and/or UV region of the spectrum with simultaneously a high transmittance of at least 0.50 in the visible region.

The invention is further explained below with reference to some non-limitative embodiment examples.

### EXAMPLES

### Example 1

1 wt.-% of a copper hydroxide phosphate (CHP) (average particle size d50=2.27 μm) was added to a PP granulated material. The mixture was introduced into a heatable kneader (Brabender Plastograph). The absorber material was thereby evenly distributed in the melted polymer material or incorporated into the material.

The thus-produced plastics-based material was shaped to form a thin sheet with a thickness of 500 μm. The radiation absorption of the sheet was measured with a spectrophotometer (Varian Cary 5000). A complete radiation absorption was measured in the UV region below 380 nm. Also in the region 800 nm and above (near-infrared region), the transmittance was less than 0.03, i.e. an almost complete absorption was also measured here. In the region of the wavelengths of the visible light, the transmittance was >0.50 and was thus not substantially impaired by the absorber material.

### Example 2

1 wt.-% of a copper pyrophosphate and 1 wt.-% of a copper orthophosphate were added to a PE granulated material. The copper phosphate compounds were incorporated into the plastic by means of extrusion and evenly distributed.

The thus-produced polymer material was shaped to form a thin sheet with a thickness of 600 μm. The radiation absorption of the sheet was measured with a spectrophotometer (Varian Cary 5000). A very high radiation absorption (transmittance<0.10) of the sheet to which copper phosphates were added was measured in the UV region below 400 nm.

Also in the region of 850 nm and above (near-infrared region) the transmittance was less than 0.1. As desired, the transparency is high in the region of the visible wavelengths (transmittance approximately 0.8).

### Example 3

1 wt.-% of a CHP (copper hydroxide phosphate) was added to a PET granulated material. The copper hydroxide phosphate was incorporated into the plastic by means of extrusion and evenly distributed.

The thus-produced polymer material was shaped to form a thin sheet with a thickness of 600 μm. The radiation absorption of the sheet was measured with a spectrophotometer (Varian Cary 5000). A very high radiation absorption of over 90% was measured in the UV region below 400 nm. Also in the region of 850 nm and above (near-infrared region) the transmittance was less than 0.1.

As desired, the transparency is high in the region of the visible wavelengths (transmittance>0.80).

1. Radiation-absorbing, plastics-based material consisting of a polymer matrix with an absorber material or mixture of absorber materials contained therein, wherein the absorber material or mixture of absorber materials is selected from phosphates, condensed phosphates, phosphonates, phosphites and mixed hydroxide-phosphate-oxoanions of copper (Cu), tin (Sn), calcium (Ca) and/or iron (Fe) and is present finely distributed, dispersed or dissolved in the polymer matrix.

2. Material according to claim 1, wherein the absorber material is selected from tritin phosphate (CAS 15578-32-3), tricopper diphosphate (CAS 7798-23-4), copper diphosphate (CAS 10102-90-6), copper hydroxide phosphate (CAS 12158-74-6) and mixtures thereof.

3. Material according to claim 1, wherein the absorber material is present finely distributed, dispersed or dissolved in the polymer matrix in a quantity of from 0.0005 to 10 wt.-% or from 0.05 to 5 wt.-% or from 0.5 to 3 wt.-% or from 1 to 2 wt.-%.

4. Material according to claim 1, wherein the polymer matrix is a biopolymer, preferably comprising starch, cellulose, other polysaccharides, polylactic acid or polyhydroxy fatty acid, or a thermoplastic polymer, preferably selected from the group consisting of polyvinyl butyral (PVB), polypropylene (PP), polyethylene (PE), polyamide (PA), polybutylene terephthalate (PBT), polyethylene terephthalate (PET), polyester, polyphenylene oxide, polyacetal, polymethacrylate, polyoxymethylene, polyvinyl acetal, polystyrene, acryl-butadiene-styrene (ABS), acrylonitrile-styrene-acrylester (ASA), polycarbonate, polyethersulphone, polyetherketone, polyvinyl chloride, thermoplastic polyurethane and/or their copolymers and/or mixtures thereof.

5. Material according to claim 1, wherein the absorber material has an average particle size (d50) of less than 20 μm, preferably less than 10 μm, particularly preferably less than 200 nm, quite particularly preferably less than 60 nm or 50 nm or 40 nm.

6. Material according to claim 1, wherein it is present as a film, layer or thin sheet with a thickness in the range of from 1 μm to 20 mm or in the range of from 50 μm to 10 mm or in the range of from 100 μm to 5 mm or in the range of from 200 μm to 1 mm.

7. Material according to one of the previous claims claim 1, wherein a mixture of at least two absorber materials is present in the polymer matrix.

8. Material according to claim 1, wherein the absorber material or the mixture of absorber materials has a bacteriostatic and/or sterilizing effect.

9. Material according to claim 1, wherein in addition at least one bacteriostatic and/or sterilizing agent is present finely distributed, dispersed or dissolved in the polymer matrix.

10. Material according to claim 1, wherein it has a transmittance I_{T}/I₀ of ≦0.60, preferably ≦0.50, particularly preferably ≦0.30 for ultraviolet radiation (UV) over the wavelength range of from 200 to 380 nm, preferably from 200 to 400 nm, wherein I₀=intensity of the incident radiation and I_{T}=intensity of the penetrating radiation.

11. Material according to claim 1, wherein it has a transmittance I_{T}/I₀ of ≦0.50, preferably ≦0.30, particularly preferably <0.25 for infrared radiation (IR/NIR) over the wavelength range of from 900 to 1500 nm, wherein I₀=intensity of the incident radiation and I_{T}=intensity of the penetrating radiation.

12. Material according to claim 1, wherein it has a transmittance I_{T}/I₀ of >0.60, preferably >0.70, particularly preferably >0.80 for visible light (VIS) over the wavelength range of from 400 to 900 nm, wherein I₀=intensity of the incident radiation and I_{T}=intensity of the penetrating radiation.

13. Material according to claim 1, wherein it is formed as a film, layer or thin sheet with a thickness in the range of from 1 μm to 3 mm and is present with at least one further layer in a multi-ply structure, wherein the at least one further layer is selected from a film-type or layer-type polymer matrix with or without absorber material, an aluminium layer and/or a paper or cardboard layer.

14. Use of the material according to claim 1 for producing packaging materials for commercial products, preferably packaging materials for foodstuffs, cosmetics or medical products, or for producing medical products, plastic tubes, roofs, windows or noise protection elements.
